(19) United States
(12) Patent Application Publication
(10) Pub. No.: US 2014/0320465 A1
(43) Pub. Date: Oct. 30, 2014

(54) Display Device For Low Speed Drive And Method For Driving The Same

(71) Applicant: LG Display Co., Ltd., Seoul (KR)

(72) Inventors: Daeseok OH, Paju-si (KR); Saichang YUN, Daegu (KR); Juyoung LEE, Paju-si (KR); Bogun SEO, Paju-si (KR); Yousung NAM, Gwangmyeong-si (KR); Yonghwa PARK, Paju-si (KR)

(73) Assignee: LG Display Co., Ltd., Seoul (KR)

(21) Appl. No.: 14/263,733

(22) Filed: Apr. 28, 2014

(30) Foreign Application Priority Data
Apr. 30, 2013 (KR) 10-2013-0048142

(51) Int. Cl. G09G 5/18

(52) U.S. Cl. CPC G09G 5/18
USPC 345/204

(57) ABSTRACT

A display device for low speed drive includes a display panel including gate lines, data lines, and pixels respectively formed at crossings of the gate lines and the data lines, a source driver supplying data voltages to the data lines, a gate driver supplying a gate pulse to the gate lines, and a timing controller which time-divides one frame into n sub-frames, where n is a positive integer equal to or greater than 2, groups the gate lines into n gate groups, controls an operation of the gate driver in each of the n sub-frames to complete a scan operation of a corresponding gate group during a scan period of each of the n sub-frames, generates a buffer operation control signal, and cuts off a driving power source applied to buffers of the source driver during a skip period excluding the scan period from each of the n sub-frames.

### CROSS-REFERENCE TO RELATED APPLICATION

This application claims priority under 35 U.S.C. §119(a) to Korean Patent Application No. 10-2013-0048142 filed on Apr. 30, 2013, which is incorporated herein by reference in its entirety.

### BACKGROUND OF THE INVENTION

1. Field of the Invention

Embodiments of the invention relate to a display device for low speed drive and a method for driving the same.

2. Discussion of the Related Art

Display devices have been used in various display units, such as portable information devices, office devices, computers, and televisions. The display device includes a display panel for displaying an image and a driver for driving the display panel. A plurality of data lines and a plurality of gate lines are formed on the display panel, and pixels are respectively formed at crossings of the data lines and the gate lines. The driver includes a source driver for driving the data lines and a gate driver for driving the gate lines.

Various methods for reducing power consumption of the display device are known, one of which is a low speed driving technology. Low speed driving technology refreshes the entire screen of the display device at a frame frequency less than an input frame frequency. Low speed driving technology may be implemented through an interlaced drive shown in FIG. 1. In the interlaced drive, one frame is time-divided into a plurality of sub-frames, and the different gate lines are driven in each of the sub-frames. Namely, the gate lines are dividedly driven in the sub-frames, thereby implementing the interlaced drive.

As one example of the interlaced drive, when an image is input from a host at an input frame frequency of 60 Hz as shown in FIG. 1, the display device divides one frame into first and second sub-frames SF1 and SF2 as shown in FIG. 2. The display device sequentially scans odd-numbered gate lines G1, G3, G5, and G7 in the first sub-frame SF1 and sequentially scans even-numbered gate lines G2, G4, G6, and G8 in the second sub-frame SF2. Hence, the interlaced drive of 30 Hz is implemented. One gate time (indicating a charge time of pixels disposed on one horizontal line) required to scan one gate line in the interlaced drive of 30 Hz is represented as ‘2H’ and is two times longer than one gate time ‘1H’ in a normal drive of 60 Hz.

As another example, when the image is input from the host at the input frame frequency of 60 Hz as shown in FIG. 1, the display device divides one frame into first to fourth sub-frames SF1 to SF4 as shown in FIG. 3. The display device sequentially scans (4m+1)th gate lines G1 and G5 in the first sub-frame SF1, where m is a non-negative integer, sequentially scans (4m+2)th gate lines G2 and G6 in the second sub-frame SF2, sequentially scans (4m+3)th gate lines G3 and G7 in the third sub-frame SF3, and sequentially scans (4m+4)th gate lines G4 and G8 in the fourth sub-frame SF4. Hence, the interlaced drive of 15 Hz is implemented. One gate time required to scan one gate line in the interlaced drive of 15 Hz is represented as ‘4H’ and is four times longer than one gate time ‘1H’ in the normal drive of 60 Hz.

In the interlaced drive, as the number of sub-frames increases, a length of time to process one whole frame increases. Hence, the frame frequency is reduced. As the frame frequency gradually decreases from 60 Hz for the low speed drive, a data transition frequency (used in the supply of a data voltage) of the source driver decreases.

As shown in FIG. 4, the source driver includes a first digital-to-analog converter P-DAC for converting input digital video data into a positive gamma compensation voltage, a first buffer BUF1 for buffering and outputting the positive gamma compensation voltage, a second digital-to-analog converter N-DAC for converting the input digital video data into a negative gamma compensation voltage, and a second buffer BUF2 for buffering and outputting the negative gamma compensation voltage. A high potential driving voltage VDD, a ground level voltage GND, and a driving voltage HVDD (hereinafter referred to as “middle potential driving voltage”) having a middle potential of the voltages VDD and GND are applied to the first buffer BUF1 and the second buffer BUF2. The first buffer BUF1 includes a first input unit PI operating by the high potential driving voltage VDD and the ground level voltage GND and a first output unit PO operating by the high potential driving voltage VDD and the middle potential driving voltage HVDD. The second buffer BUF2 includes a second input unit NI operating by the high potential driving voltage VDD and the ground level voltage GND and a second output unit NO operating by the middle potential driving voltage HVDD and GND.

A static current SIDD flows between an input terminal of the high potential driving voltage VDD and the first buffer BUF1 and between the second buffer BUF2 and an input terminal of the ground level voltage GND. A first dynamic current DIDD1 is discharged from the first output unit PO, or a second dynamic current DIDD2 enters the first output unit PO through a switching operation of the first output unit PO. Further, a third dynamic current DIDD3 is discharged from the second output unit NO, or a fourth dynamic current DIDD4 enters the second output unit NO through a switching operation of the second output unit NO. When a high gray level image is implemented, the first and third dynamic currents DIDD1 and DIDD3 enter the data lines. Further, when a low gray level image is implemented, the second and fourth dynamic currents DIDD2 and DIDD4 flow from the data lines.

When the data transition frequency decreases due to the low speed drive, the dynamic current flowing through the buffers of the source driver decreases. Therefore, power consumption of the source driver is slightly reduced.

However, after a predetermined period of time, the dynamic current in the low speed drive will become saturated to a level corresponding to the static current at a predetermined time point. Furthermore, because the static current is always generated irrespective of a reduction in the data transition frequency resulting from the low speed drive, the existing low speed driving technology is limited in how sharply it can reduce the power consumption of the source driver.

### SUMMARY OF THE INVENTION

Embodiments of the invention comprise a display device for low speed drive and a method for driving the same capable of greatly reducing power consumption of a source driver by preventing the generation of a static current in a portion of each sub-frame during a low speed drive.

In one embodiment a display device for low speed drive comprises a display panel formed with a plurality of gate lines and a plurality of data lines intersecting the plurality of data lines, wherein a pixel is defined by each crossing of the gate lines and the data lines, a source driver configured to supply data voltages to the data lines, a gate driver configured to supply a gate pulse to the gate lines, and a timing controller configured to time-divide one frame into n sub-frames, where n is a positive integer equal to or greater than 2, group the gate lines into n gate groups, control an operation of the gate driver in each of the n sub-frames to complete a scan operation of a corresponding gate group during a scan period corresponding to a portion of each of the n sub-frames, generate a buffer operation control signal, and cut off a driving power source applied to buffers of the source driver according to the buffer operation control signal during a skip period corresponding to a remaining period excluding the scan period from each of the n sub-frames.

In an embodiment, the scan period occupies 1/n of a length of each of the n sub-frames, and the skip period following the scan period occupies (n−1)/n of the length of each of the n sub-frames.

In an embodiment, the timing controller sets one gate time required to scan one gate line in each of the n sub-frames to ‘1H’ defined by a length of one frame divided by the number of gate lines and sets a distance between rising edges of adjacent gate pulses in a same sub-frame to ‘1H’.

In an embodiment, a scan operation of the gate driver and a data voltage supply operation of the source driver are skipped during the skip period of each of the n sub-frames.

In an embodiment, the buffer operation control signal is generated at an on-level during the scan period of each of the n sub-frames and is generated at an off-level during the skip period of each of the n sub-frames.

In an embodiment, the buffers of the source driver include a first buffer including a first input unit operating by a high potential driving voltage and a ground level voltage and a first output unit operating by the high potential driving voltage and a middle potential driving voltage, the first buffer buffering and outputting a positive gamma compensation voltage, a second buffer including a second input unit operating by the high potential driving voltage and the ground level voltage and a second output unit operating by the middle potential driving voltage and the ground level voltage, the second buffer buffering and outputting a negative gamma compensation voltage, a first power switch connected between an input terminal of the high potential driving voltage and the first output unit, and a second power switch connected between an input terminal of the ground level voltage and the second output unit, wherein the first and second power switches are turned on in response to the buffer operation control signal during the scan period of each of the n sub-frames and are turned off in response to the buffer operation control signal during the skip period of each of the n sub-frames.

In another embodiment, a method includes steps for driving a display device for low speed drive including a display panel, on which a plurality of gate lines and a plurality of data lines cross each other and a pixel is formed at each crossing of the gate lines and the data lines, a source driver supplying data voltages to the data lines, and a gate driver supplying a gate pulse to the gate lines, the method comprising time-dividing one frame into n sub-frames, where n is a positive integer equal to or greater than 2, and grouping the gate lines into n gate groups, controlling an operation of the gate driver in each of the n sub-frames to complete a scan operation of a corresponding gate group during a scan period corresponding to a portion of each of the n sub-frames, and generating a buffer operation control signal and cutting off a driving power source applied to buffers of the source driver according to the buffer operation control signal during a skip period corresponding to a remaining period excluding the scan period from each of the n sub-frames.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates changes in a frame frequency during an interlaced drive, as compared with a normal drive;

FIG. 2 shows an example of a conventional interlaced drive;

FIG. 3 shows another example of a conventional interlaced drive;

FIG. 4 shows a partial configuration of a conventional source driver;

FIG. 5 is a block diagram of a display device for low speed drive according to an exemplary embodiment of the invention;

FIG. 6 shows an interlaced drive implemented by time-dividing one frame into n sub-frames and dividedly driving gate lines in the n sub-frames;

FIG. 7 is a diagram showing scan and skip portions of a drive according to an exemplary embodiment of the invention;

FIG. 8 shows example waveforms in which a gate time is set so that a scan and skip drive can be implemented;

FIG. 9 shows in detail a partial configuration of a source driver according to an exemplary embodiment of the invention;

FIG. 10 illustrates a switching operation of switches shown in FIG. 9 during scan periods and skip periods of first and second sub-frames during 30 Hz interlaced drive;

FIGS. 11 to 14 show various examples of an interlaced drive, to which an exemplary embodiment of the invention is applied; and

FIG. 15 illustrates the reduction of power consumption resulting from an exemplary embodiment of the invention being applied to an interlaced drive of 20 Hz, 12 Hz, 4 Hz, and 1 Hz.

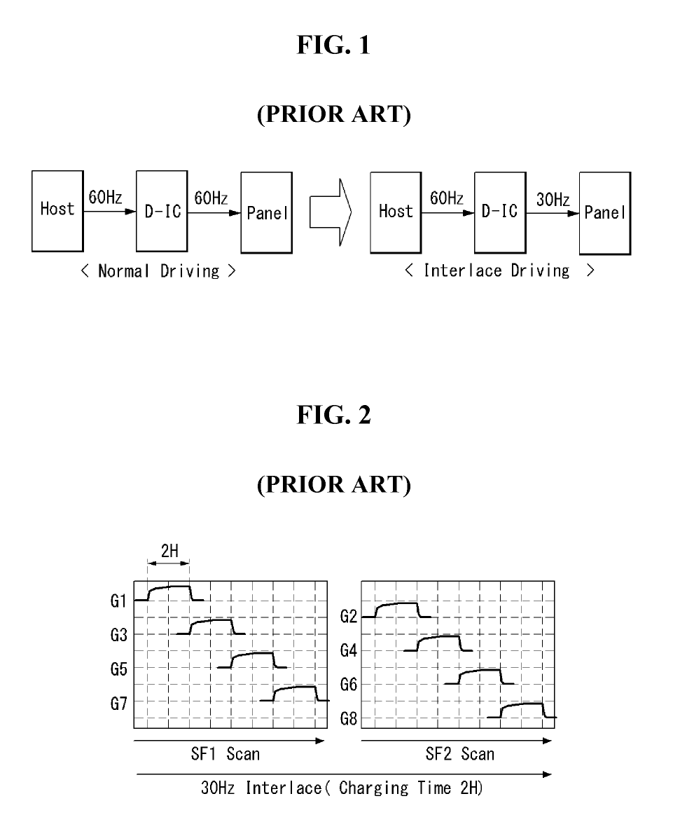

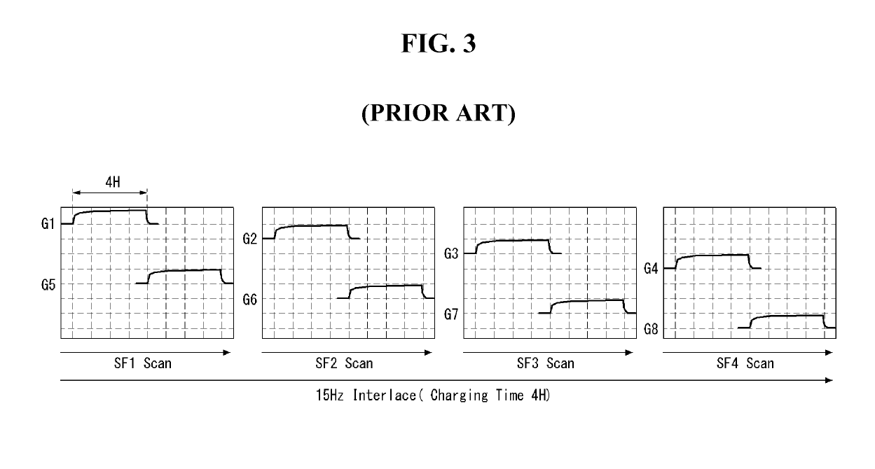

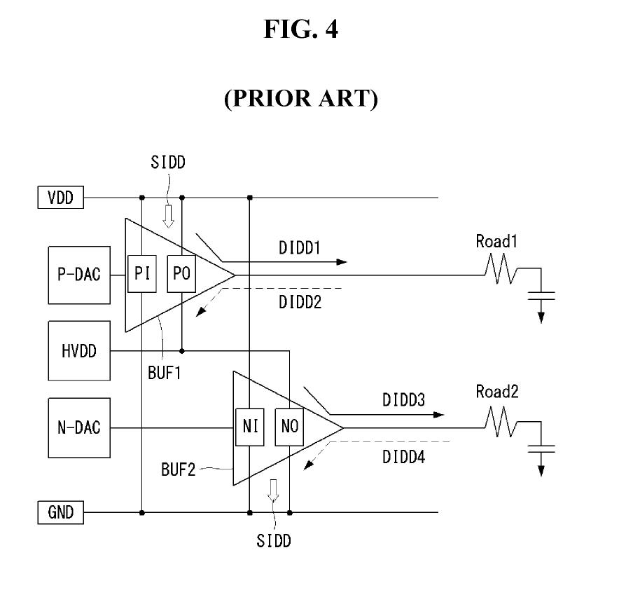

### DETAILED DESCRIPTION OF THE ILLUSTRATED EMBODIMENTS

Reference will now be made in detail to embodiments of the invention, examples of which are illustrated in the accompanying drawings. Wherever possible, the same reference numbers will be used throughout the drawings to refer to the same or like parts. It will be paid attention that detailed description of known arts will be omitted if it is determined that the arts can mislead the embodiments of the invention.

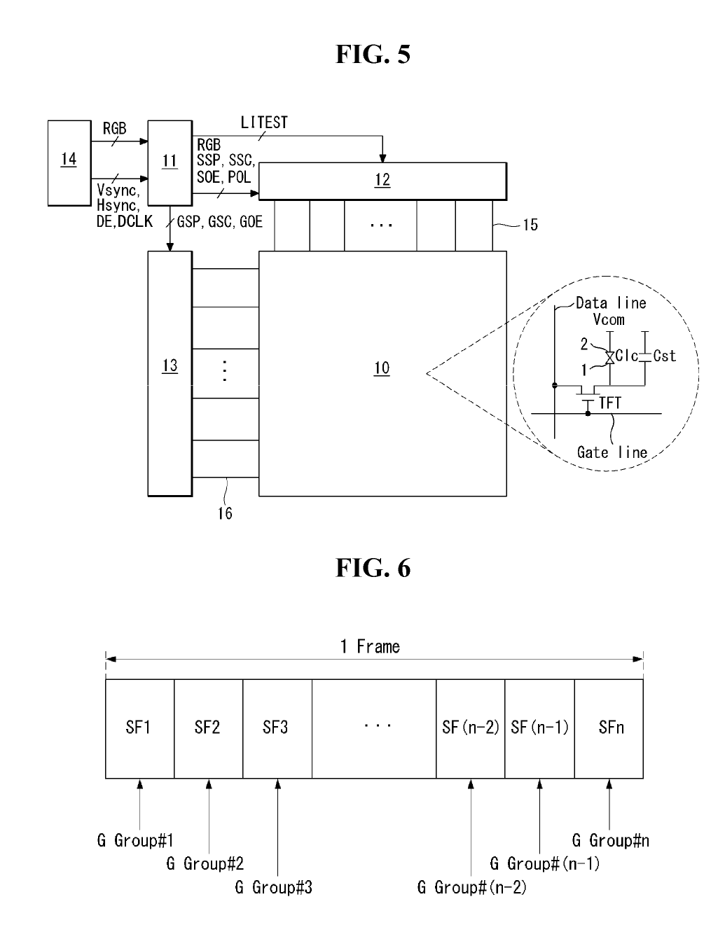

Exemplary embodiments of the invention will be described with reference to FIGS. 5 to 15.

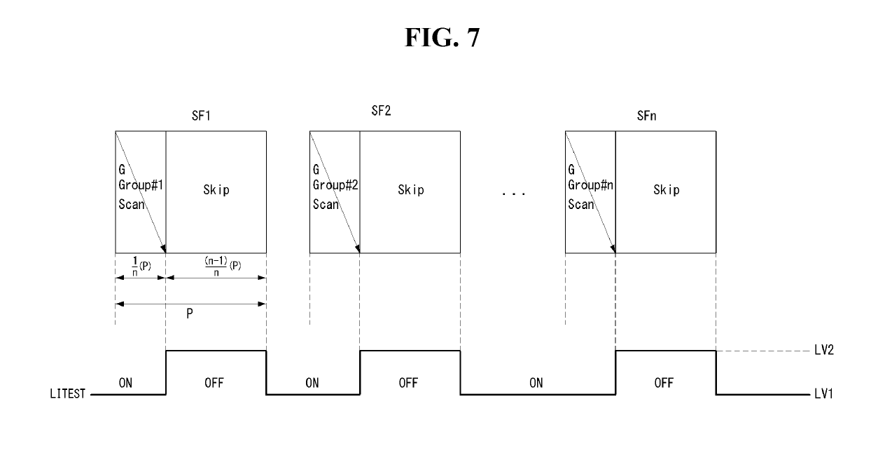

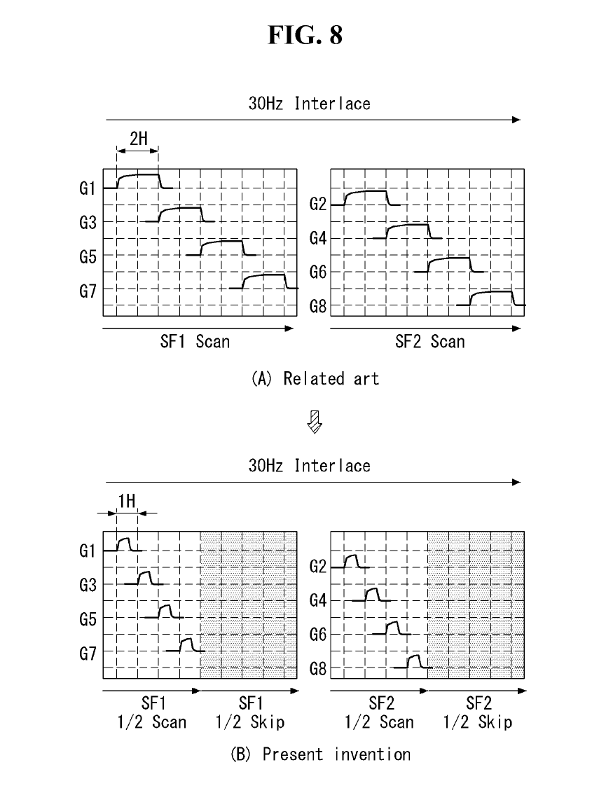

FIG. 5 is a block diagram of a display device for low speed drive according to an exemplary embodiment of the invention. FIG. 6 shows an interlaced drive implemented by time-dividing one frame into n sub-frames and dividedly driving gate lines in the n sub-frames. FIG. 7 is a diagram showing scan and skip portions of a drive according to the embodiment of the invention. FIG. 8 shows example waveforms in which a gate time is set so that a scan and skip drive can be implemented.

As shown in FIG. 5, the display device for low speed drive according to the embodiment of the invention may be implemented as a flat panel display, such as a liquid crystal display (LCD), a field emission display (FED), a plasma display panel (PDP), an organic light emitting display, or an electrophoresis display (EPD). In the following description, the embodiment of the invention will be described using a liquid crystal display as an example of the flat panel display. Other flat panel displays may be used.

A liquid crystal display panel 10 includes a lower glass substrate, an upper glass substrate, and a liquid crystal layer formed between the lower glass substrate and the upper glass substrate. The liquid crystal display panel 10 includes liquid crystal cells Clc which are arranged in a matrix form based on a crossing structure of data lines 15 and gate lines 16.

A pixel array is formed on the lower glass substrate of the liquid crystal display panel 10. The pixel array includes the liquid crystal cells (i.e., pixels) Clc formed at crossings of the data lines 15 and the gate lines 16, thin film transistors (TFTs) connected to pixel electrodes 1 of the pixels, common electrodes 2 positioned opposite the pixel electrodes 1, and storage capacitors Cst. Each liquid crystal cell Clc is connected to the TFT and is driven by an electric field between the pixel electrode 1 and the common electrode 2. Black matrixes, red, green, and blue color filters, etc. are formed on the upper glass substrate of the liquid crystal display panel 10. Polarizing plates are respectively attached to the upper and lower glass substrates of the liquid crystal display panel 10. Alignment layers for setting a pre-tilt angle of liquid crystals are respectively formed on the upper and lower glass substrates of the liquid crystal display panel 10.

The common electrodes 2 are formed on the upper glass substrate in a vertical electric field driving manner such as a twisted nematic (TN) mode and a vertical alignment (VA) mode. The common electrodes 2 are formed on the lower glass substrate along with the pixel electrodes 1 in a horizontal electric field driving manner such as an in-plane switching (IPS) mode and a fringe field switching (FFS) mode.

The liquid crystal display panel 10 applicable to the embodiment of the invention may be implemented in any liquid crystal mode including the TN mode, the VA mode, the IPS mode, the FFS mode, etc. The liquid crystal display according to the embodiment of the invention may be implemented as any type liquid crystal display including a transmissive liquid crystal display, a transflective liquid crystal display, and a reflective liquid crystal display. The transmissive liquid crystal display and the transflective liquid crystal display require a backlight unit. The backlight unit may be implemented as a direct type backlight unit or an edge type backlight unit.

The timing controller 11 receives digital video data RGB of an input image from a host system 14 through a low voltage differential signaling (LVDS) interface and supplies the digital video data RGB of the input image to a source driver 12 through a mini LVDS interface. The timing controller 11 arranges the digital video data RGB received from the host system 14 in conformity with a disposition configuration of the pixel array and then supplies the arranged digital video data RGB to the source driver 12.

The timing controller 11 receives timing signals, such as a vertical sync signal Vsync, a horizontal sync signal Hsync, a data enable signal DE, and a dot clock DCLK, from the host system 14 and generates control signals for controlling operation timings of the source driver 12 and a gate driver 13. The control signals include a gate timing control signal for controlling operation timing of the gate driver 13 and a source timing control signal for controlling operation timing of the source driver 12.

The gate timing control signal includes a gate start pulse GSP, a gate shift clock GSC, a gate output enable signal GOE, etc. The gate start pulse GSP is applied to a gate driver integrated circuit (IC) generating a first gate pulse and controls the gate driver ICs so that the first gate pulse is generated. The gate shift clock GSC is commonly input to gate driver ICs of the gate driver 13 and shifts the gate start pulse GSP. The gate output enable signal GOE controls an output of the gate driver ICs.

The source timing control signal includes a source start pulse SSP, a source sampling clock SSC, a polarity control signal POL, a source output enable signal SOE, etc. The source start pulse SSP controls data sampling start timing of the source driver 12. The source sampling clock SSC controls sampling timing of data in the source driver 12 based on its rising or falling edge. The polarity control signal POL controls polarities of data voltages sequentially output from each of source driver ICs of the source driver 12. The source output enable signal SOE controls output timing of the source driver 12.

The timing controller 11 controls an operation of the source driver 12 and an operation of the gate driver 13, so as to implement a low speed drive through an interlaced drive. The timing controller 11 generates the gate timing control signal and the source timing control signal so that the digital video data RGB input at a frame frequency of 60 Hz may be refreshed in the pixel array of the liquid crystal display panel 10 based on a frame frequency of 60/n Hz, where n is a positive integer.

As shown in FIG. 6, the timing controller 11 time-divides one frame into n sub-frames, where n is a positive integer equal to or greater than 2, and dividedly drives the gate lines 16 in the n sub-frames, thereby implementing the interlaced drive. Further, as shown in FIG. 6, the timing controller 11 groups the gate lines 16 into n gate groups G Group#1 to G Group#n and causes the n gate groups G Group#1 to G Group#n to respectively correspond to the n sub-frames in conformity with the driving order of the n gate groups.

The timing controller 11 controls the operation of the gate driver 13 in each sub-frame and completes the sequential scan of the gate lines included in the corresponding gate group during a “1/n” period (also referred to herein as a scan period) of one sub-frame. Further, the timing controller 11 generates a buffer operation control signal LITEST (refer to FIG. 7) and cuts off a driving power source (for example, a high potential driving voltage and a ground level voltage) applied to the buffers of the source driver 12 during a remaining period (referred to herein as an “(n−1)/n” period or a skip period), which excludes the “1/n” period from the one sub-frame.

In other words, as shown in FIG. 7, the timing controller 11 controls the operation of the gate driver 13 during the “1/n” period having a length P/n of a first sub-frame SF1 having a length P and scans the gate lines 16 belonging to the first gate group G Group#1. The timing controller 11 controls the operation of the source driver 12 and supplies the data voltage synchronized with the scan of the first gate group G Group#1 to the data lines 15. Further, the timing controller 11 controls the operation of the gate driver 13 during the “1/n” period having a length P/n of a second sub-frame SF2 having a length P and scans the gate lines 16 belonging to the second gate group G Group#2. The timing controller 11 controls the operation of the source driver 12 and supplies the data voltage synchronized with the scan of the second gate group G Group#2 to the data lines 15. Further, the timing controller 11 controls the operation of the gate driver 13 during the “1/n” period having a length P/n of an nth sub-frame SFn having a length P and scans the gate lines 16 belonging to the nth gate group G Group#n. The timing controller 11 controls the operation of the source driver 12 and supplies the data voltage synchronized with the scan of the nth gate group G Group#n to the data lines 15.

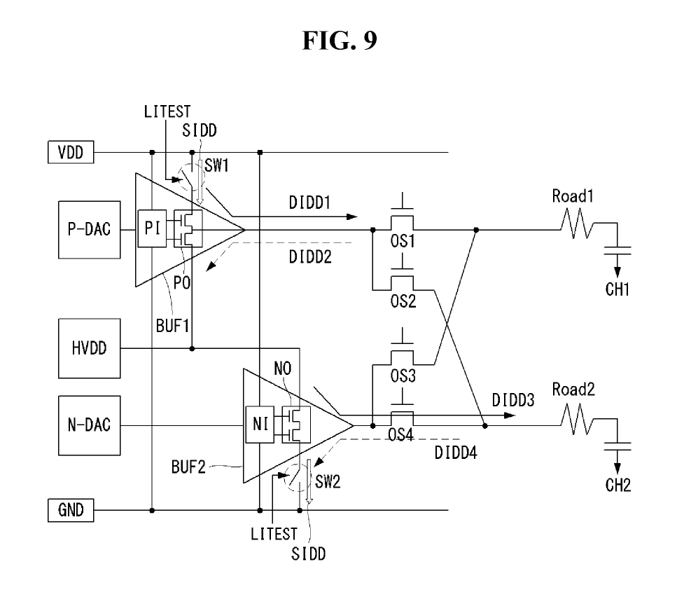

As shown in FIG. 7, the timing controller 11 skips a scan operation of the gate driver 13 and a data voltage supply operation of the source driver 12 during the “(n−1)/n” period having a length P(n−1)/n excluding the “1/n” period having a length P/n (assigned to the scan operation) from each of the first to nth sub-frames SF1 to SFn each having the length P. As shown in FIG. 7, the timing controller 11 generates the buffer operation control signal LITEST at an on-level LV1 during the “1/n” period (i.e., scan period) having a length P/n assigned to the scan operation in each of the n sub-frames SF1 to SFn and generates the buffer operation control signal LITEST at an off-level LV2 during the “(n−1)/n” period having a length P(n−1)/n, in which the scan operation is skipped, in each of the n sub-frames SF1 to SFn, thereby controlling switching operations of first and second power switches SW1 and SW2 of the source driver 12 shown in FIG. 9. FIG. 7 shows an example where the first level LV1 indicates the on-level and the second level LV2 indicates the off-level. However, the on-level and the off-level may change depending on a type (for example, p-type and n-type) of the first and second power switches SW1 and SW2 shown in FIG. 9. The driving power source (for example, the high potential driving voltage and the ground level voltage) applied to the buffers of the source driver 12 is not cut off when the buffer operation control signal LITEST is generated at the first level LV1, but is cut off when the buffer operation control signal LITEST is generated at the second level LV2. The timing controller 11 controls the operation of the source driver 12, so that the drive of the source driver 12 is skipped during the remaining period (i.e., skip period) having a length P(n−1)/n after the scan operation is completed in each of the n sub-frames SF1 to SFn. The timing controller 11 cuts off the driving power source applied to the source driver 12 and removes a static current flowing in the buffers of the source driver 12. Hence, power consumption of the source driver 12 is greatly reduced.

The source driver 12 includes a shift register, a latch array, a digital-to-analog converter, an output circuit, and the like. The source driver 12 latches the digital video data RGB in response to the source timing control signal and converts the latched digital video data RGB into positive and negative analog gamma compensation voltages. The source driver 12 then supplies the data voltages, of which polarities are inverted every predetermined period of time, to the data lines 15 through a plurality of output channels. The output circuit includes a plurality of buffers. The buffers are connected to the output channels of the source driver 12, and the output channels are respectively connected to the data lines 15. The source driver 12 controls the polarities of the data voltages output from the output channels through a column inversion scheme so as to reduce the power consumption of the source driver 12. According to the column inversion scheme, the polarity of the data voltage output from the same output channel is inverted in a cycle of one sub-frame, and polarities of the data voltages output from the adjacent output channels are opposite to each other.

The gate driver 13 supplies the gate pulse to the gate lines 16 in response to the gate timing control signal using a shift register and a level shifter through the above-described interlaced driving scheme. The shift register of the gate driver 13 may be directly formed on the lower glass substrate of the liquid crystal display panel 10 through a gate driver-in panel (GIP) process.

In the related art, one gate time (referring to a charge time of pixels disposed on one horizontal line) required to scan one gate line in an interlaced drive of 60/n Hz is n times longer than one gate time ‘1H’ (herein, defined by a length P of one frame divided by the number of gate lines) in a normal drive of 60 Hz. On the other hand, in the embodiment of the invention, one gate time in the 60/n Hz interlaced drive is set to the same value ‘1H’ as the normal drive. For example, as shown in FIG. 8, in the interlaced drive of 30 Hz, in which one frame is time-divided into two sub-frames, one gate time was set to 2H in the related art, but one gate time is set to 1H in the embodiment of the invention. Further, a rising time of each gate pulse in the embodiment of the invention is earlier than the related art by 1H. Hence, the embodiment of the invention can perform a high speed scan operation (involving the sequential scan of all of the gate lines assigned to a sub-frame using only a portion of the sub-frame) in each sub-frame.

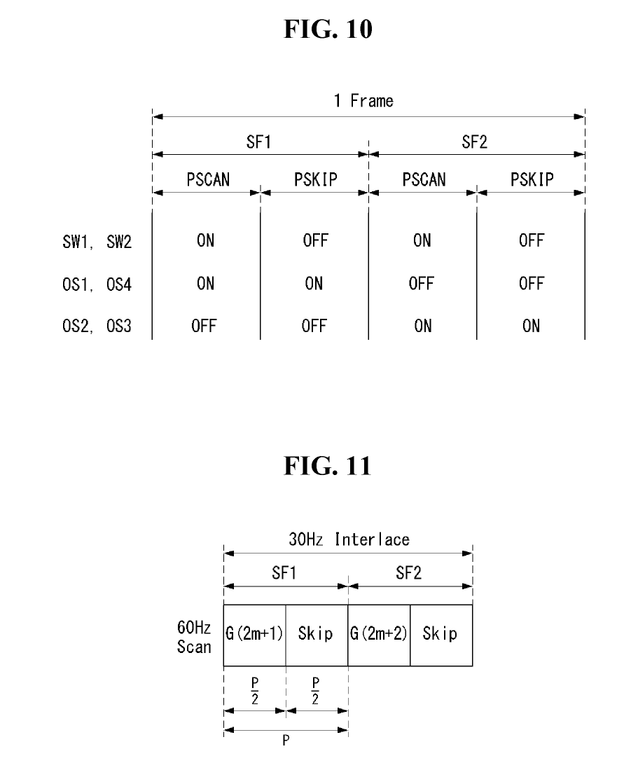

FIG. 9 shows in detail a partial configuration of the source driver 12. FIG. 10 illustrates a switching operation of switches shown in FIG. 9 during scan periods and skip periods of first and second sub-frames during 30 Hz interlaced drive.

As shown in FIG. 9, the source driver 12 includes a first digital-to-analog converter P-DAC for converting the input digital video data into the positive gamma compensation voltage, a first buffer BUF1 for buffering and outputting the positive gamma compensation voltage, a second digital-to-analog converter N-DAC for converting the input digital video data into the negative gamma compensation voltage, and a second buffer BUF2 for buffering and outputting the negative gamma compensation voltage.

A high potential driving voltage VDD, a ground level voltage GND, and a driving voltage HVDD (hereinafter referred to as “middle potential driving voltage”) having a middle potential of the voltages VDD and GND are applied to the first buffer BUF1 and the second buffer BUF2. A voltage level of the middle potential driving voltage HVDD may correspond to about one half of the high potential driving voltage VDD and may be substantially equal to a common voltage Vcom applied to the liquid crystal display panel 10.

The first buffer BUF1 includes a first input unit PI operating by the high potential driving voltage VDD and the ground level voltage GND and a first output unit PO operating by the high potential driving voltage VDD and the middle potential driving voltage HVDD. The second buffer BUF2 includes a second input unit NI operating by the high potential driving voltage VDD and the ground level voltage GND and a second output unit NO operating by the the middle potential driving voltage HVDD and the ground level voltage GND.

A first dynamic current DIDD1 is discharged from the first output unit PO, or a second dynamic current DIDD2 enters the first output unit PO through a switching operation of the first output unit PO. Further, a third dynamic current DIDD3 is discharged from the second output unit NO, or a fourth dynamic current DIDD4 enters the second output unit NO through a switching operation of the second output unit NO. In the embodiment disclosed herein, when a high gray level image is implemented, the first and third dynamic currents DIDD1 and DIDD3 enter the data lines through output channels CH1 and CH2. Further, when a low gray level image is implemented, the second and fourth dynamic currents DIDD2 and DIDD4 flow from the data lines via the output channels CH1 and CH2.

The source driver 12 may include first to fourth polarity inversion switches OS1, OS2, OS3, and OS4, so that the polarities of the data voltages output from the adjacent output channels CH1 and CH2 are opposite to each other, and the polarity of the data voltage output from the same output channel is inverted in a cycle of one sub-frame. The on-time of the first and fourth polarity inversion switches OS1 and OS4 and the on-time of the second and third polarity inversion switches OS2 and OS3 may alternate with each other in a cycle of one sub-frame. When the first and fourth polarity inversion switches OS1 and OS4 are turned on in odd-numbered sub-frames of one frame, the second and third polarity inversion switches OS2 and OS3 may be turned on in even-numbered sub-frames of the one frame. For example, as shown in FIG. 10, the first and fourth polarity inversion switches OS1 and OS4 are turned on in the first sub-frame SF1 and are turned off in the second sub-frame SF2 in the 30 Hz interlaced drive. On the other hand, the second and third polarity inversion switches OS2 and OS3 are turned off in the first sub-frame SF1 and are turned on in the second sub-frame SF2 in the 30 Hz interlaced drive. The embodiment of the invention may reduce the number of first digital-to-analog converters P-DAC and the number of second digital-to-analog converters N-DAC by one half through an alternate operation of the polarity inversion switches OS1, OS2, OS3, and OS4.

The related art source driver had a structure, in which a static current SIDD always flows between an input terminal of the high potential driving voltage VDD and the first buffer BUF1 and the static current SIDD flows between the second buffer BUF2 and an input terminal of the ground level voltage GND. Because the static current was always generated irrespective of a reduction in a data transition frequency resulting from the low speed drive in the related art, the related art had a limitation of a sharp reduction in power consumption of the source driver.

The embodiment of the invention includes a first power switch SW1 connected between the input terminal of the high potential driving voltage VDD and the first output unit PO and a second power switch SW2 connected between the input terminal of the ground level voltage GND and the second output unit NO, so as to completely block the static current in the skip period of each sub-frame.

The first and second power switches SW1 and SW2 are turned on or off in response to the buffer operation control signal LITEST input from the timing controller 11. The first and second power switches SW1 and SW2 are turned on in response to the buffer operation control signal LITEST having the on-level LV1 during a scan period PSCAN (refer to FIG. 10) of each sub-frame and are turned off in response to the buffer operation control signal LITEST having the off-level LV2 during a skip period PSKIP (refer to FIG. 10) of each sub-frame. When the first and second power switches SW1 and SW2 are turned off during the skip period PSKIP of each sub-frame, a closed loop, through which the static current can flow, is blocked. Thus, the static current flowing between the input terminal of the high potential driving voltage VDD and the first buffer BUF1 and the static current flowing between the second buffer BUF2 and the input terminal of the ground level voltage GND are completely blocked in the skip period PSKIP of each sub-frame.

FIGS. 11 to 14 show various examples of the interlaced drive, to which the embodiment of the invention is applied.

FIG. 11 shows an example of 30 Hz interlaced drive, to which the embodiment of the invention is applied. As shown in FIG. 11, the embodiment of the invention divides one frame into first and second sub-frames SF1 and SF2 and dividedly scans gate lines G(2m+1) and G(2m+2) of first and second groups in the first and second sub-frames SF1 and SF2 based on a driving frequency of 60 Hz, where m is a non-negative integer. In this instance, the embodiment of the invention sets one gate time required to scan one gate line and a distance between rising edges of adjacent gate pulses in the same sub-frame to ‘1H’ and can perform a high speed scan operation (indicating the completion of a scan operation during a period P/2, where P is a length of one sub-frame). Hence, the embodiment of the invention produces a skip period having a length of P/2 in each of the first and second sub-frames SF1 and SF2. Further, the embodiment of the invention turns off the first and second power switches SW1 and SW2 added to the source driver 12 during the skip period, thereby blocking the static current flowing between the input terminal of the high potential driving voltage VDD and the first buffer BUF1 and the static current flowing between the second buffer BUF2 and the input terminal of the ground level voltage GND.

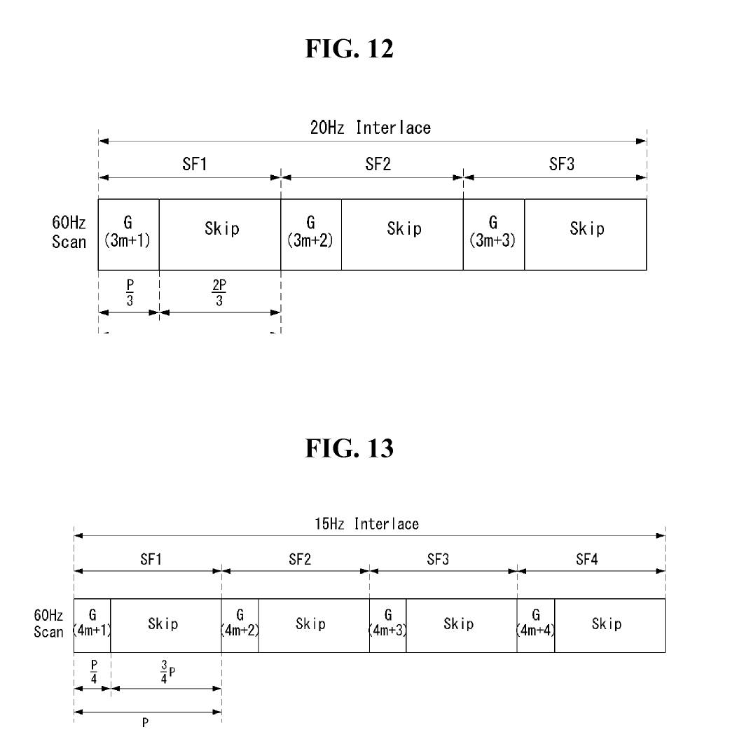

FIG. 12 shows an example of 20 Hz interlaced drive, to which the embodiment of the invention is applied. As shown in FIG. 12, the embodiment of the invention divides one frame into first to third sub-frames SF1 to SF3 and dividedly scans gate lines G(3m+1) to G(3m+3) of first to third groups in the first to third sub-frames SF1 to SF3 based on the driving frequency of 60 Hz, respectively. In this instance, the embodiment of the invention sets one gate time required to scan one gate line and a distance between rising edges of adjacent gate pulses in the same sub-frame to ‘1H’ and can perform a high speed scan operation (indicating the completion of a scan operation during a period P/3, where P is a length of one sub-frame). Hence, the embodiment of the invention produces a skip period having a length of 2P/3 in each of the first to third sub-frames SF1 to SF3. Further, the embodiment of the invention turns off the first and second power switches SW1 and SW2 added to the source driver 12 during the secured skip period, thereby blocking the static current flowing between the input terminal of the high potential driving voltage VDD and the first buffer BUF1 and the static current flowing between the second buffer BUF2 and the input terminal of the ground level voltage GND.

FIG. 13 shows an example of 15 Hz interlaced drive, to which the embodiment of the invention is applied. As shown in FIG. 13, the embodiment of the invention divides one frame into first to fourth sub-frames SF1 to SF4 and dividedly scans gate lines G(4m+1) to G(4m+4) of first to fourth groups in the first to fourth sub-frames SF1 to SF4 based on the driving frequency of 60 Hz, respectively. In this instance, the embodiment of the invention sets one gate time required to scan one gate line and a distance between rising edges of adjacent gate pulses in the same sub-frame to ‘1H’ and can perform a high speed scan operation (indicating the completion of a scan operation during a period P/4, where P is a length of one sub-frame). Hence, the embodiment of the invention produces a skip period having a length of 3P/4 in each of the first to fourth sub-frames SF1 to SF4. Further, the embodiment of the invention turns off the first and second power switches SW1 and SW2 added to the source driver 12 during the secured skip period, thereby blocking the static current flowing between the input terminal of the high potential driving voltage VDD and the first buffer BUF1 and the static current flowing between the second buffer BUF2 and the input terminal of the ground level voltage GND.

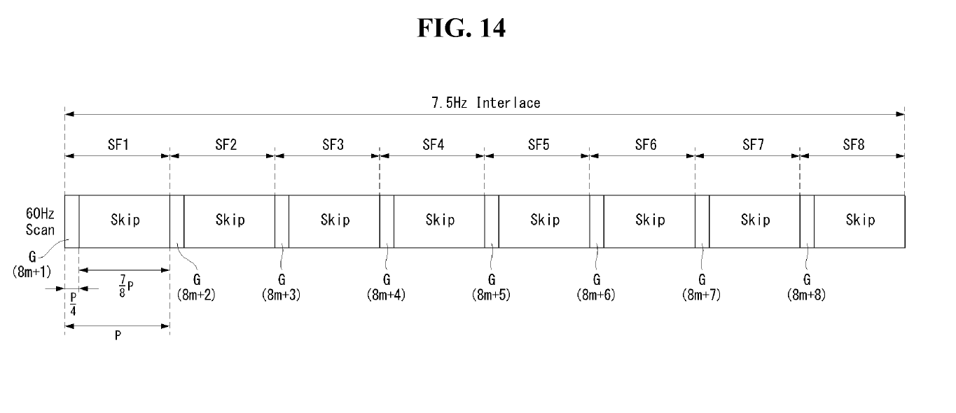

FIG. 14 shows an example of 7.5 Hz interlaced drive, to which the embodiment of the invention is applied. As shown in FIG. 14, the embodiment of the invention divides one frame into first to eighth sub-frames SF1 to SF8 and dividedly scans gate lines G(8m+1) to G(8m+8) of first to eighth groups in the first to eighth sub-frames SF1 to SF8 based on the driving frequency of 60 Hz, respectively. In this instance, the embodiment of the invention sets one gate time required to scan one gate line and a distance between rising edges of adjacent gate pulses in the same sub-frame to ‘1H’ and can perform a high speed scan operation (indicating the completion of a scan operation during a period P/8, where P is a length of one sub-frame). Hence, the embodiment of the invention produces a skip period having a length of 7P/8 in each of the first to eighth sub-frames SF1 to SF8. Further, the embodiment of the invention turns off the first and second power switches SW1 and SW2 added to the source driver 12 during the secured skip period, thereby blocking the static current flowing between the input terminal of the high potential driving voltage VDD and the first buffer BUF1 and the static current flowing between the second buffer BUF2 and the input terminal of the ground level voltage GND.

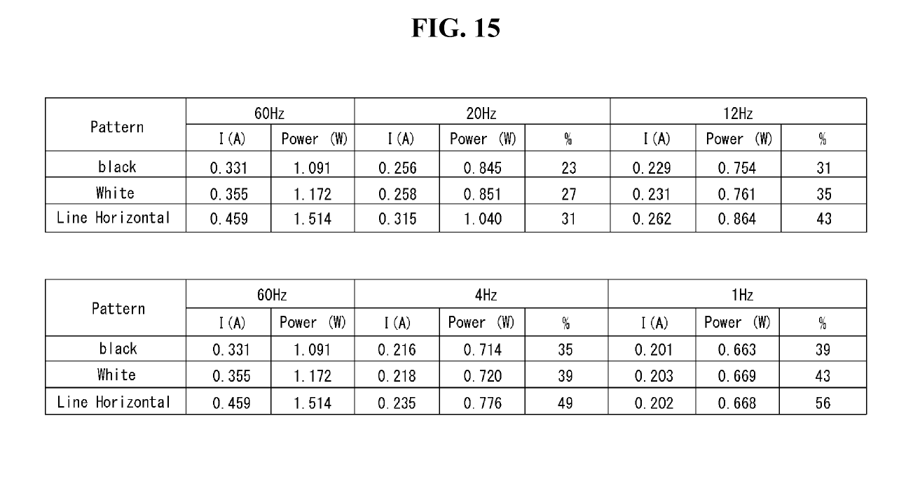

FIG. 15 illustrates the reduction of power consumption resulting from an embodiment of the invention being applied to the interlaced drive of 20 Hz, 12 Hz, 4 Hz, and 1 Hz.

As shown in FIG. 15, the power consumptions when the embodiment of the invention is applied to the interlaced drive of 20 Hz, 12 Hz, 4 Hz, and 1 Hz are greatly reduced, as compared with the power consumption in the normal drive of 60 Hz. Reduction percentages of the power consumption of a black pattern, a white pattern, and a horizontal line pattern increases in the order named.

As described above, the embodiment of the invention adjusts one gate time and the rising time of the gate pulse during the low speed drive using the interlaced driving technology, thereby completing the scan operation during a portion (i.e., the scan period) of each sub-frame. Further, the embodiment of the invention prevents the static current of the source driver from being generated during the remaining period (i.e., the skip period) of each sub-frame, thereby greatly reducing the power consumption.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device for low speed drive comprising:
a display panel formed with a plurality of gate lines and a plurality of data lines intersecting with the plurality of gate lines, wherein a pixel is defined by each crossing of the gate lines and the data lines;
a source driver configured to supply data voltages to the data lines;
a gate driver configured to supply a gate pulse to the gate lines; and
a timing controller configured to time-divide each frame of received data into n sub-frames, where n is a positive integer equal to or greater than 2, group the gate lines into n gate groups, control an operation of the gate driver in each sub-frame of the n sub-frames to complete a scan operation of the corresponding gate group during a scan period corresponding to a portion of each of the n sub-frames, generate a buffer operation control signal, and cut off a driving power source applied to buffers of the source driver according to the buffer operation control signal during a skip period corresponding to a remaining period excluding the scan period from each of the n sub-frames.

2. The display device for low speed drive of claim 1, wherein the scan period occupies 1/n of a length of each of the n sub-frames, and the skip period following the scan period occupies (n−1)/n of the length of each of the n sub-frames.

3. The display device for low speed drive of claim 1, wherein the timing controller sets one gate time required to scan one gate line in each of the n sub-frames to ‘1H’ defined by a length of one frame divided by the number of gate lines and sets a distance between rising edges of adjacent gate pulses in a same sub-frame to ‘1H’.

4. The display device for low speed drive of claim 1, wherein a scan operation of the gate driver and a data voltage supply operation of the source driver are skipped during the skip period of each of the n sub-frames.

5. The display device for low speed drive of claim 1, wherein the buffer operation control signal is generated at an on-level during the scan period of each of the n sub-frames and is generated at an off-level during the skip period of each of the n sub-frames.

6. The display device for low speed drive of claim 1, wherein the buffers of the source driver include:
a first buffer including a first input unit operating by a high potential driving voltage and a ground level voltage and a first output unit operating by the high potential driving voltage and a middle potential driving voltage, the first buffer buffering and outputting a positive gamma compensation voltage;
a second buffer including a second input unit operating by the high potential driving voltage and the ground level voltage and a second output unit operating by the middle potential driving voltage and the ground level voltage, the second buffer buffering and outputting a negative gamma compensation voltage;
a first power switch connected between an input terminal of the high potential driving voltage and the first output unit; and
a second power switch connected between an input terminal of the ground level voltage and the second output unit,
wherein the first and second power switches are turned on in response to the buffer operation control signal during the scan period of each of the n sub-frames and are turned off in response to the buffer operation control signal during the skip period of each of the n sub-frames.

7. A method for driving a display device for low speed drive including a display panel formed with a plurality of gate lines and a plurality of data lines intersecting the plurality of gate lines, wherein a pixel is defined by each crossing of the gate lines and the data lines, a source driver supplying data voltages to the data lines, and a gate driver supplying a gate pulse to the gate lines, the method comprising:
time-dividing one frame into n sub-frames, where n is a positive integer equal to or greater than 2;
grouping the gate lines into n gate groups;
controlling an operation of the gate driver in each sub-frame to complete a scan operation of a corresponding gate group during a scan period corresponding to a portion of each of the n sub-frames; and
generating a buffer operation control signal and cutting off a driving power source applied to buffers of the source driver according to the buffer operation control signal during a skip period corresponding to a remaining period excluding the scan period from each of the n sub-frames.

8. The method of claim 7, wherein the scan period occupies 1/n of a length of each of the n sub-frames, and the skip period following the scan period occupies (n−1)/n of the length of each of the n sub-frames.

9. The method of claim 7, wherein one gate time required to scan one gate line in each of the n sub-frames is set to ‘1H’ defined by a length of one frame divided by the number of gate lines, and a distance between rising edges of adjacent gate pulses in a same sub-frame is set to ‘1H’.

10. The method of claim 7, wherein a scan operation of the gate driver and a data voltage supply operation of the source driver are skipped during the skip period of each of the n sub-frames.

11. The method of claim 7, wherein the buffer operation control signal is generated at an on-level during the scan period of each of the n sub-frames and is generated at an off-level during the skip period of each of the n sub-frames.

12. The method of claim 7, wherein a current path between a first output unit of the buffers of the source driver and an input terminal of a high potential driving voltage and a current path between a second output unit of the buffers of the source driver and an input terminal of a ground level voltage are skipped during the skip period of each of the n sub-frames in response to the buffer operation control signal.
